(19) United States
(12) Patent Application Publication
(10) Pub. No.: US 2005/0030735 A1
(43) Pub. Date: Feb. 10, 2005

(54) Electroluminescent light band for vehicles

(76) Inventor: Shaw Jong Wang, Hsinchu County (TW)

Correspondence Address: WENDEROTH, LIND & PONACK, L.L.P., 2033 K STREET N. W., SUITE 800, WASHINGTON, DC, 20006-1021, US

(21) Appl. No.: 10/776,281

(22) Filed: Feb. 12, 2004

(30) Foreign Application Priority Data
Aug. 6, 2003 (TW) 092214280

(51) Int. Cl. F21V 9/16

(52) U.S. Cl. 362/84

(57) ABSTRACT

An electroluminescent light band for vehicles comprises an electroluminescence device and a front pattern sheet. The luminous surface of the electroluminescence device has at least two luminous regions including a redirection-displaying region and a pattern exchangeable region. The redirection-displaying region can show the moving direction of a driven car, that is, it indicates a right turn or a left turn synchronized with the turn signal of the car. The exchangeable pattern region allows a car owner to put his favor front pattern sheet on the luminous surface of the electroluminescence device, such as a translucent sheet with a personal creative pattern or colorful advertisement picture. Furthermore, miniature suction cups placed at the luminous surface of the electroluminescence device are capable of repeatedly sticking on the rear window of the car so as to allow easy change of the front pattern sheets.

### BACKGROUND OF THE INVENTION

1. Field of the Invention

The present invention relates to an electroluminescent light band for vehicles, and more particularly to a decorative band capable of showing the current driving direction of a vehicle by its light.

2. Description of the Related Art

In crowded cities, some drivers drive in a dangerous manner to fight for priority on roads, but this behavior is dangerous and forces other drivers to concentrate all of their attention on driving defensively. This also gives passengers of a vehicle the fear that a traffic accident might happen. On one hand, the drivers must drive carefully to avoid a collision from any lateral direction. On the other hand, they have to keep their eyes on the vehicles in front of them to keep a safe distance between them. For the sake of traffic safety, drivers have to enhance their driving skills and obey traffic rules, moreover if warning signals or direction indicators are provided on vehicle bodies, they would be helpful for other drivers to take notice of one's direction of motion and current position.

FIG. 1 is a perspective schematic diagram of a car having conventional turn signals capable of indicating its current direction of motion, wherein the turn signals 11 are included in the rear lights of a car 10. The driver of a following car can notice the turning direction of a preceding car as indicated by its turn signals 11 and keep a safe distance. However, even though the rear lights that incorporate brake lights can also show whether or not the preceding car is braking, the two cars might still collide with each other due delay in braking because the driver cannot observe taillight. Therefore, the current car 10 always has an auxiliary braking light 12 behind its rear window, hence large-size vehicles, such as trucks and buses, can observe that the auxiliary braking light 12 of the preceding car is switched on when the brake is stepped on. However, the car 10 with the auxiliary braking light 12 also cannot show its moving direction at the level of the rear window. Traffic accidents still occur frequently because the moving direction of the preceding car cannot be instantaneously observed.

In summary, a display apparatus, showing the moving direction of the car, is necessary for the vehicle market to resolve the aforesaid problem. Furthermore, the moving car can be decorated with a billboard as a mobile advertisement. Furthermore, conventional billboards have too many disadvantages, such as disorderliness, bulkiness and dullness, to attractive the attentions of pedestrians. It is necessary to improve the mobile advertisement medium.

### SUMMARY OF THE INVENTION

An objective of the present invention is to provide an electroluminescent light band for vehicles capable of multiple sticking on the rear window of a car to show its moving direction so as to help the driver of a following car to keep a safe distance from the proceeding car.

The second objective of the present invention is to provide an electroluminescent light band with the replacement of a decorative front sheet. The owner of a car can choose his favorite transparent picture as the decorative front sheet and place it in front of the luminous surface of an electroluminescence device. The electroluminescent light band can show much creativeness and personality of the car owner.

In order to achieve the objective, the present invention discloses an electroluminescent light band for vehicles, comprising an electroluminescence device and a front pattern sheet. The luminous surface of the electroluminescence device has at least two luminous regions including a redirection-displaying region and an exchangeable pattern region. The redirection-displaying region can show the moving direction of a driving car, that is, it indicates a right turn or a left turn synchronized with the turn signal of the car. The exchangeable pattern region allows a car owner to put his favorite front pattern sheet on the luminous surface of the electroluminescence device, such as a translucent sheet with a personal creative pattern or colorful advertisement picture. Furthermore, miniature suction cups placed on the luminous surface of the electroluminescence device are capable of multiple sticking on the rear window of the car so as to allow easy change the front pattern sheets.

### BRIEF DESCRIPTION OF THE DRAWINGS

The invention will be described according to the appended drawings in which:

FIG. 1 is a perspective schematic diagram of a car having conventional turn signals capable of indicating its current driven direction;

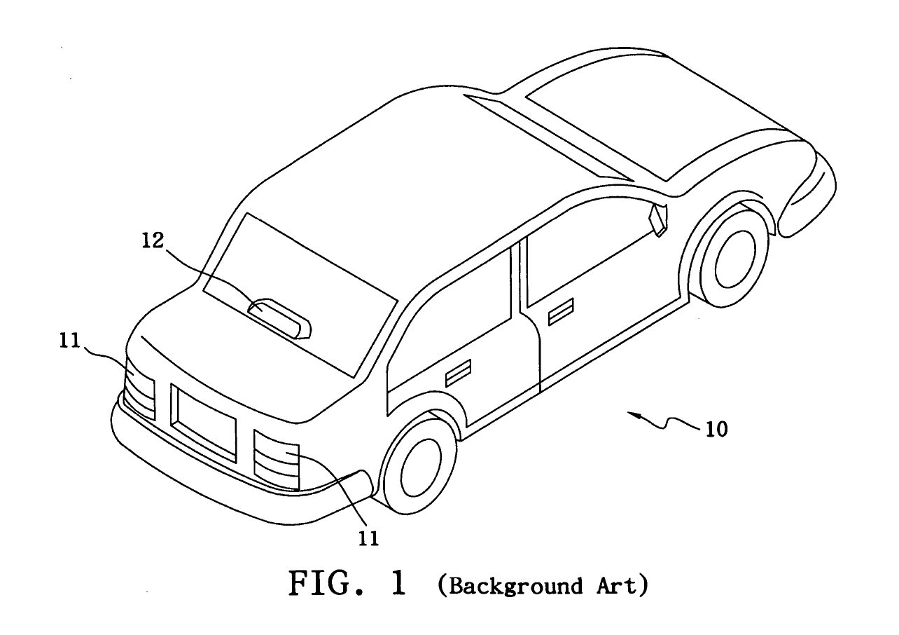

FIG. 2 is a diagram of the electroluminescent light band of the present invention applied to a car;

FIG. 3 is a front view of an electroluminescent light band in accordance with the present invention;

FIG. 4 is a cross-sectional diagram taken along the line B-B in FIG. 3; and

FIG. 5 is a diagram of an electroluminescent light band in accordance with another embodiment of the present invention.

### PREFERRED EMBODIMENT OF THE PRESENT INVENTION

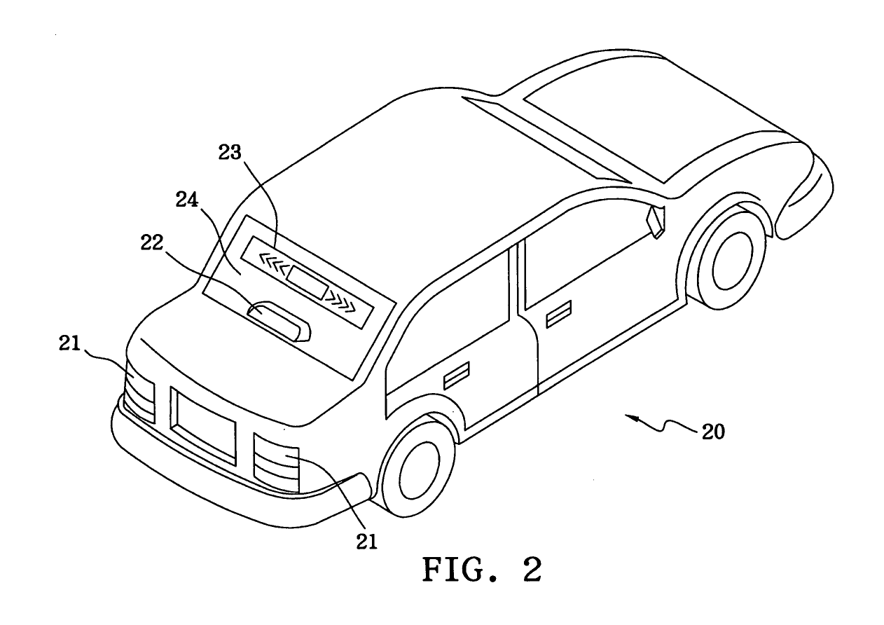

FIG. 2 is a diagram of the electroluminescent light band of the present invention applied to a car. Besides turn signals 21 placed at the rear lights of a car 20 for showing turn directions and an auxiliary braking light 22 placed at the low edge of the rear window 24, the present invention further provides an electroluminescent light band 23 capable of multiple sticking on the rear window 24. The driver of a following car can clearly observe the indication from the turn direction of the electroluminescent light band 23. The driver of the car 20 is also able to show his personality from a front decorative sheet on the electroluminescent light band 23.

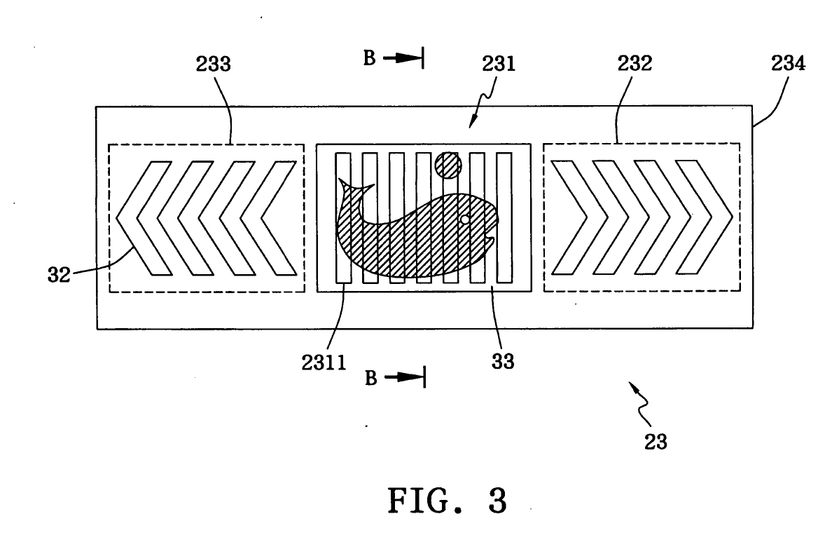

As shown in FIG. 3, the electroluminescent light band 23 comprises an electroluminescence device 234 divided into a right turn indication region 232, a left turn indication region 233 and an exchangeable pattern region 231. The right turn indication region 232 has a luminescent arrow 31 with a head towards the right, and the left turn indication region 233 similarly has a luminescent arrow 32 with a head towards the left. The luminescent arrow 31 and 32 are separately driven by the driving signals as right and left turn signals 21 separately receive. That is, the luminescent arrow 31 of the right turn indication region 232 twinkles when the right turn signal 21 is intermittently switched on. The luminescent arrow 31 also can gradually sequentially light up from its leftmost area to its rightmost area, and then switch off both areas. Furthermore, the right turn indication region 232 and left turn indication region 233 simultaneously light up as the braking lights of rear lights would after the brake of the car 20 is stepped on.

The exchangeable pattern region 231 has a front pattern sheet 33 with a colorful print on its surface. The colorful print on the front pattern sheet 33, a translucent plastic sheet, is highlighted by the electroluminescent light from the electroluminescence device 234 at an inferior layer. The electroluminescent light band 23 can have an attractive visual effect caused from changing the lighting modes of the exchangeable pattern region 231, such as twinkle, sequentially lightening sub luminescent areas 2311 and randomly lighting or darkening these. Through various lighting changes applied to the exchangeable pattern region 231 and the front pattern sheet 33 having a colorful picture, the electroluminescent light band 23 not only indicates the turn direction of the car 20, but also enriches the appearance of the car body and shows the personal favor of the car owner.

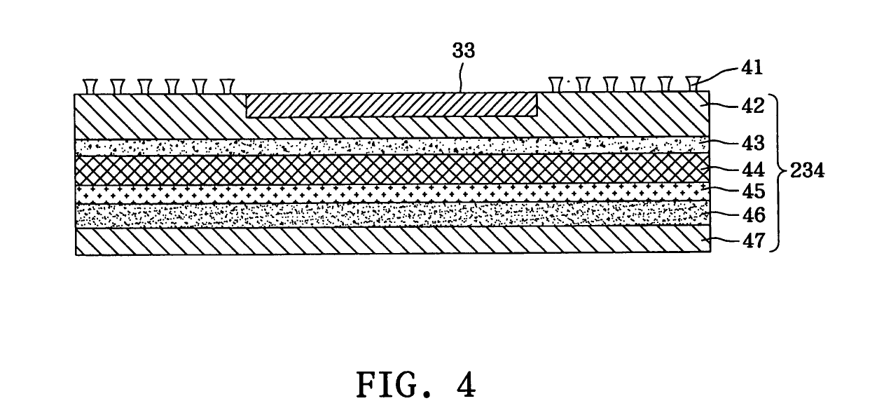

FIG. 4 is a cross-sectional diagram taken along the line B-B in FIG. 3. The electroluminescence device 234 includes a lower plastic substrate 47, a front bus bar layer 46, an isolation layer 45, electroluminescent layer 44, an ITO (Indium Tin Oxide) layer 43 and an upper plastic substrate 42. The electroluminescent layer 44 emits electroluminescent light through the upper plastic substrate 42 to its environment after excited by electrical energy. Therefore, the exposed surface of the upper plastic substrate 42 is defined as a luminous surface. The front pattern sheet 33 attached to the surface of the upper plastic substrate 42 has a translucent picture accompanied by the electroluminescent light to bring about a shiny, colorful visual effect. In order to easily stick the electroluminescent light band 23 to the rear window of a car, a plurality of miniature suction cups 41, transparent small-scale suction discs, are formed on the surface of the upper plastic substrate 42. Because there are many miniature suction cups 41 distributed over the surface of the upper plastic substrate 42, a suction force caused from these is not smaller than one caused from ordinary suction cups. Furthermore, the miniature suction cups 41 do not degrade the appearance of the luminous surface. If the car owner likes to replace the current one of the front pattern sheet 33 with another, he just takes the electroluminescent light band 23 from the rear window and changes the one with another thereon.

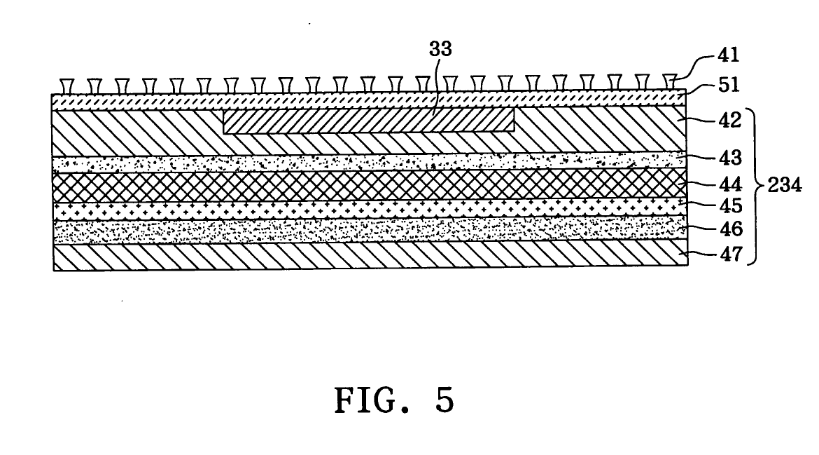

Because a car is often parked outdoors, an anti-UV protection layer 51 is placed on the surface of the upper plastic substrate 42 to prevent the damage of the electroluminescence device 234 or the front pattern sheet 33 caused from sunlight, as shown in FIG. 5. There are also a plurality of miniature suction cups 41 on the surface of the anti-UV protection layer 51 for easy multiple sticking the electroluminescent light band 23 to the rear window.

The above-described embodiments of the present invention are intended to be illustrative only. Numerous alternative embodiments may be devised by persons skilled in the art without departing from the scope of the following claims.

1. An electroluminescent light band for vehicles capable of being attached to a car's rear window, comprising:
an electroluminescence device, including:
at least one exchangeable pattern region; and
at least one redirection-displaying region; and
at least one front pattern sheet placed over the exchangeable pattern region and being a thin material with a translucent pattern.

2. The electroluminescent light band for vehicles of claim 1, further comprising a plurality of miniature suction caps for attaching the electroluminescent light band to the rear window.

3. The electroluminescent light band for vehicles of claim 1, further comprising an anti-UV protection layer covering the electroluminescence device and the front pattern sheet.

4. The electroluminescent light band for vehicles of claim 1, wherein the exchangeable pattern region has a plurality of sub luminescent areas.

5. The electroluminescent light band for vehicles of claim 4, wherein the sub luminescent areas can flickeringly light simultaneously or flickeringly light sequentially.

6. The electroluminescent light band for vehicles of claim 1, wherein the redirection-displaying region includes turn-right and turn-left indications.

7. The electroluminescent light band for vehicles of claim 1, wherein the redirection-displaying region includes a plurality of arrow-shaped sub luminescent areas which are used to display turn-right and turn-left indications.

8. The electroluminescent light band for vehicles of claim 7, wherein the arrow-shaped sub luminescent areas can flickeringly light simultaneously or flickeringly light sequentially.

9. The electroluminescent light band for vehicles of claim 6, wherein the turn-right and turn-left indications light simultaneously when the brake of the car is suddenly stepped on.
